(19) United States
(12) Patent Application Publication
(10) Pub. No.: US 2008/0070499 A1
(43) Pub. Date: Mar. 20, 2008

(54) MAGNETIC COMMUNICATION THROUGH METAL BARRIERS

(75) Inventors: Graham R. Wilhelm, Alexandria, VA (US); Corey Jaskolski, Alexandria, VA (US); Eric Berkenpas, Alexandria, VA (US)

Correspondence Address: COCHRAN FREUND & YOUNG LLC, 2026 CARIBOU DR, SUITE 201, FORT COLLINS, CO, 80525, US

(73) Assignee: HYDRO TECHNOLOGIES, INC., Windsor, CO (US)

(21) Appl. No.: 11/857,792

(22) Filed: Sep. 19, 2007

Related U.S. Application Data
(60) Provisional application No. 60/826,200, filed on Sep. 19, 2006.

(51) Int. Cl. H04B 5/00

(52) U.S. Cl. 455/41.1

(57) ABSTRACT

A wireless magnetic through-hull communications apparatus and method which permit higher data-rate communications through materials than presently available using acoustic techniques is described. A signal source on one side of a barrier is directed into a coil driver which generates an amplified, modulated signal responsive thereto. The resulting signal is used to drive a transmitter coil which generates a time-varying magnetic field that penetrates the barrier as well as any gaps comprising water, air or other material between the barrier and the transmitter coil. On the other side of the barrier, and perhaps through additional gaps comprising water, air or other material, a receiver coil detects the time-varying magnetic field. This signal may be amplified and then digitized by a signal processor. The signal processor may then communicate with a data processing and/or display unit, another sensor or some other device. Electric power may also be transmitted through the barrier for providing power to instrumentation without the need for batteries.

### RELATED CASES

The present patent application claims the benefit of Provisional Patent Application Ser. No. 60/826,200 filed on Sep. 19, 2006 entitled “Magnetic Communication Through Metal Barriers” by Corey J. Jaskolski et al. which application is hereby incorporated by reference herein for all that it discloses and teaches.

### FIELD OF THE INVENTION

The present invention relates generally to wireless communication and, more particularly, to wireless communications through metal barriers using magnetic fields.

### BACKGROUND OF THE INVENTION

Most wireless communication is achieved using RF plane waves propagated through space. Communication using wireless magnetic fields has been accomplished using a non-propagating magnetic field upon which signals are impressed, and which is approximately localized around the transmitting device. The information contained in the signals is transmitted through a medium and received by a remote transducer using the principle of magnetic induction. Advantages of using a modulated magnetic field for close-proximity transmission of signals across an air interface, including low power requirements and improved security, are described in “Magnetic Induction: A Low-Power Wireless Alternative” by Chris Bunszel, www.rfdesign.com, pages 78-80, November 2001.

U.S. Pat. No. 5,771,438 for “Short-Range Magnetic Communication System” which issued to Vincent Palermo et al. on Jun. 23, 1998, U.S. Pat. No. 5,912,925 for “Diversity Circuit For Magnetic Communication System” which issued to Vincent Palermo et al. on Jun. 15, 1999, U.S. Pat. No. 5,982,764 for “Time-Multiplexed Short-Range Magnetic Communications” which issued to Vincent Palermo et al. on Nov. 9, 1999, and U.S. Pat. No. 6,459,882 for “Inductive Communication System And Method” which issued to Vincent Palermo et al. on Oct. 1, 2002, describe a short-range, wireless communication system through air using magnetic induction. Similarly, U.S. Pat. No. 6,424,820 for “Inductively Coupled Wireless System And Method” which issued to Wayne A. Burdick et al. on Jul. 23, 2002 describes a short-range, inductively coupled wireless communication system employing analog frequency modulation of a high-frequency carrier and magnetic coupling in air medium between a transmitting antenna and a receiving antenna.

U.S. Pat. No. 7,043,195 for “Communications System” which issued to John David Bunton et al. on May 9, 2006, describes a bidirectional communications system which can operate between parties below, or a party on and a party below, the surface of the earth or of a body of water without reliance on any connective infrastructure.

In many underwater applications it is impractical or unsafe to penetrate a pressure hull with wire penetrators for communications purposes. Additionally, traditional wireless data communications technologies will not work in most of these applications due to the hull construction. Modern pressure hull materials include aluminum, steel, and titanium depending on the specific application. The conductive nature of these hull materials results in the blockage or heavy attenuation of RF signals.

As an alternative to wireless RF communications, acoustic through-hull communications techniques have been developed (See, e.g., “Thru-Hull Communications” by Harris Acoustic Products Corporation, http://www.harrisacoustic.com/thrhulld.htm, 2005). However, acoustic communications through thick metal barriers has been found to be problematic. The most significant of difficulty includes multi-path propagation, where many “echoes” of the intended signal are generated, thereby increasing the system noise and limiting useful bandwidth. Multi-modal propagation of sound through various materials can also cause signal distortion. In addition, acoustic signals when used for this type of communication can result in a detectable acoustic signature which is undesirable for many applications.

### SUMMARY OF THE INVENTION

Accordingly, it is an object of the present invention to provide an apparatus and method for wirelessly communicating through metal barriers with no penetrators.

Another object of the present invention is to provide an apparatus and method for communicating through metal barriers without using acoustic techniques.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

To achieve the foregoing and other objects, and in accordance with the purposes of the present invention as embodied and broadly described herein, the method for wireless transmission of a signal through a metal barrier, hereof, includes the steps of: generating a signal; producing a time-varying magnetic field onto which the signal is impressed on one side of the metal barrier; and detecting the time-varying magnetic field on the opposite side of the metal barrier from the side thereof where the time-varying magnetic field is produced.

In another aspect of the present invention, and in accordance with its objects and purposes, the apparatus for wireless transmission of a signal through a metal barrier, hereof, includes in combination: means for generating a chosen signal; an electrically conductive coil effective for generating magnetic fields disposed on one side of the metal barrier; a coil driver for receiving the signal and for driving the coil such that a time-varying magnetic field is generated bearing the signal; means responsive to the time-varying magnetic field and disposed on the opposite side of the metal barrier from the coil; and means for detecting the response of the means responsive to the time-varying magnetic field.

In yet another aspect of the present invention, and in accordance with its objects and purposes, the method for bidirectional wireless transmission of a signal through a metal barrier, hereof, includes the steps of: generating a first signal; producing a first time-varying magnetic field onto which the first signal is impressed on one side of the metal barrier; detecting the first time-varying magnetic field on the opposite side of the metal barrier from the side thereof where the first time-varying magnetic field is produced;generating a second signal; producing a second time-varying magnetic field onto which the second signal is impressed on the side of the metal barrier opposite to that where the first time-varying field is produced; and detecting the second time-varying magnetic field on the side of the metal barrier where the first time-varying magnetic field is produced, whereby the wireless transmission of a signal through a metal barrier is bidirectional.

In still another aspect of the present invention, and in accordance with its objects and purposes, the apparatus for bidirectional wireless transmission of a signal through a metal barrier, hereof, includes in combination: first means for generating a first chosen signal; a first electrically conductive coil effective for generating magnetic fields disposed on one side of the metal barrier; a first coil driver for receiving the signal and for driving the first coil such that a first time-varying magnetic field is generated bearing the first signal; first means responsive to the first time-varying magnetic field and disposed on the opposite side of the metal barrier from the first coil; first means for detecting the response of the first means responsive to the first time-varying magnetic field; second means for generating a second chosen signal; a second electrically conductive coil effective for generating magnetic fields disposed on the other side of the metal barrier from the first coil; a second coil driver for receiving the second signal and for driving the second coil such that a second time-varying magnetic field is generated bearing the second signal; second means responsive to the second time-varying magnetic field and disposed on the same side of the metal barrier as the first coil; and second means for detecting the response of the second means responsive to the second time-varying magnetic field, whereby the wireless transmission of a signal through a metal barrier is bidirectional.

Benefits and advantages of the present invention include, but are not limited to, higher data-rate communications through materials than are available using present acoustic techniques, the ability to transfer data and power, increased data security, and the ability to penetrate a wide variety of media.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a block diagram of an embodiment of the magnetic induction apparatus of the present invention, showing a single transmitter and receiver for one-way transmission of signals across a metal barrier.

FIG. 2 is a schematic representation of either a transmitter or a receiver coil, or a dual use transceiver coil of the present invention, identifying the dimensions thereof.

FIG. 3 is a block diagram of another embodiment of the magnetic induction apparatus of the present invention, illustrating bidirectional signal transmission capability.

FIG. 4 is a block diagram of an embodiment of a digital signal processing apparatus for use with the magnetic induction apparatus shown in FIG. 3 hereof.

FIG. 5 is a graph of the response of the present apparatus defined as the ratio of the output voltage to the input voltage (upper curve), as a function of frequency for a 0.875″ thick, grounded slab of stainless steel.

FIG. 6 is a graph of the response of the present apparatus defined as the ratio of the output voltage to the input voltage (upper curve), as a function of frequency for a 0.125″ thick, grounded slab of 5086 aluminum.

FIG. 7 is a graph of the response of the present apparatus defined as the ratio of the output voltage to the input voltage (upper curve), as a function of frequency for a grounded, 0.45″ thick slab of glass fiber reinforced polymer comprising three approximately equal thickness layers, illustrating that the present invention is applicable to a wide variety of materials including coated metal barriers.

### DETAILED DESCRIPTION OF THE INVENTION

Briefly, the present invention includes a wireless magnetic through-hull communications system and method which permit higher data-rate communications through materials than are presently available using acoustic techniques. Signals from a sensor or other signal source on one side of a hull, wall or barrier may be signal-conditioned (by further electronic processing, such as filtering signal noise, as an example) and digitized using a signal processor. The signal processor may also perform digital modulation of the digitized signal. The modulated signal is then directed through a coil driver which generates an amplified, modulated signal. The resulting signal drives a transmitter coil which generates a time-varying magnetic field that penetrates the hull, wall or barrier as well as any gaps comprising water, air, or other material between the hull, wall or barrier and the transmitter coil. On the other side of the hull, wall or barrier (potentially with another gap between the hull or barrier and the receiver), a receiver coil or other magnetic field sensor detects the time-varying magnetic field. This signal may be amplified and then digitized by a signal processor. The signal processor may then communicate with a data processing and/or display unit, another sensor, or some other device. Since apparatus on both sides of the barrier may include both a receiver and transmitter, communications may be bidirectional. In the situation where one side of the barrier is exposed to seawater or other corrosive environments, the electrical components may require suitable isolation therefrom.

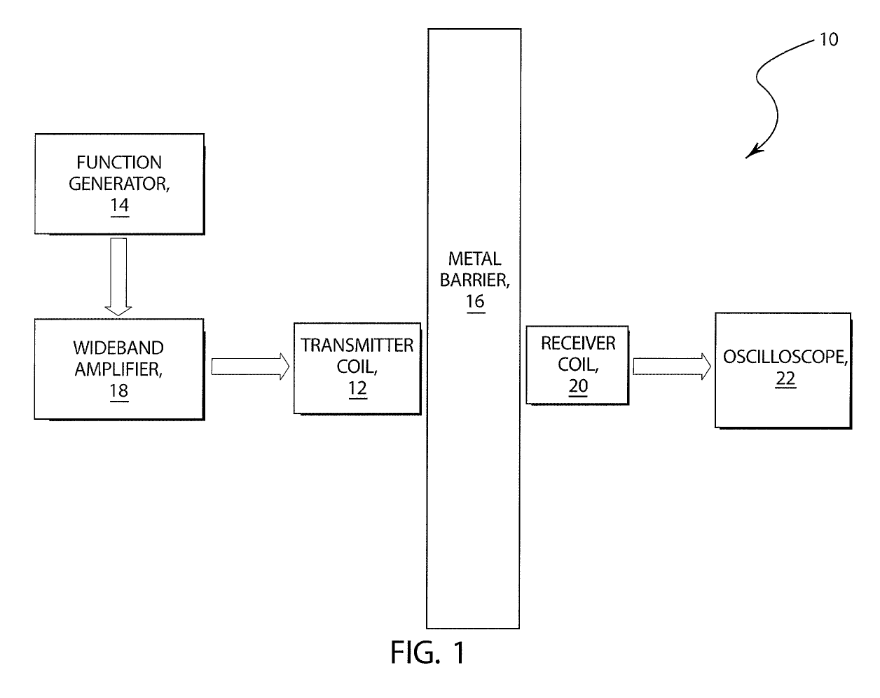

Reference will now be made in detail to the present preferred embodiments of the inventions, examples of which are illustrated in the accompanying drawings. In the Figures, similar or identical structure will be identified using identical callouts. Turning now to FIG. 1, a block diagram of an embodiment of the magnetic induction apparatus, 10, of the present invention is shown, illustrating magnetic field transmitter coil, 12, driven by function generator, 14, which provides the signal to be communicated across metal barrier, 16, through optional amplifier, 18, if required, and receiver coil, 20, responsive to the time-varying magnetic field generated by transmitter coil 12. The output of coil 20 is directed into a signal detection apparatus, 22, such as an oscilloscope, as an example. It should be mentioned that receiver coil 20 can also be used to receive power transmitted by transmitter coil 12 across barrier 16 in the event that the electrical power required by the electronics cannot readily be supplied by batteries, or in the event that the batteries utilized for this purpose require charging, as examples. The battery charging apparatus, the batteries, and the apparatus for converting the time-varying magnetic field into electrical power are not shown in the FIGURE, but would be understood by one practicing the present invention.

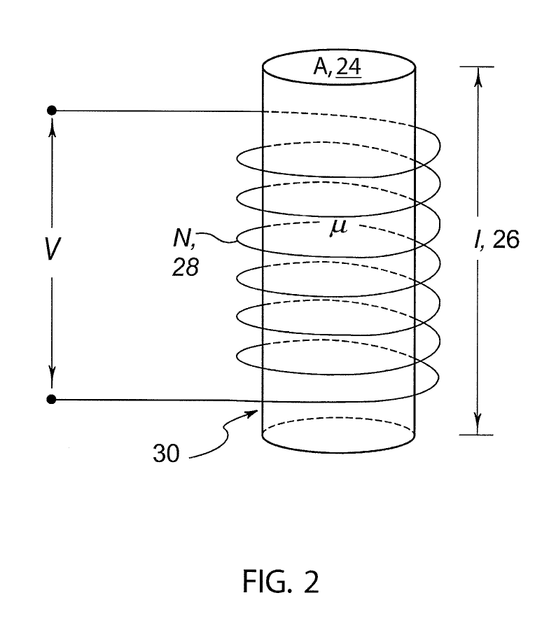

FIG. 2 is a schematic representation of an embodiment of either a transmitter 12 or a receiver coil 20 of the present invention, identifying the dimensions thereof. The electrically conductive coils hereof are characterized by cross sectional area, A, 24, length, l, 26, number of turns of wire or conductive tape, N, 28, and core, 30, permeability, μ. Voltage V is applied to transmitting coils 12, while a voltage is measured from receiving coils, 20. As stated, such coils may be fabricated using conductive wire or tape, as examples.

The use of receiver coils having smaller diameters than the transmitter coils was found to give improved results. Of the several coils tested, a 1.33″ o.d. transmitting coil (l=1″; N=200 turns; 0.44″ core diameter) and a 0.47″ o.d. receiving coil (l=0.6″; N=200 turns; 0.44″ core diameter) (approximately a 3:1 ratio) resulted in a factor of 3.4 increase in received signal amplitude (which may determine the thickness of materials through which communications can be effectively made in accordance with the teachings of the present invention), and a factor of 1.4 increase in usable bandwidth (which may determine the achievable data transmission rate), when compared with using identical diameter coils. It is believed by the present inventors that this effect may result from the shape of the generated magnetic fields. Coils employed in the following EXAMPLES were low-cost, commercially available coils typically used in electronic actuators. However, it should be mentioned that receiving time-dependent magnetic signals through a barrier may also be achieved using Hall probes or other magnetic field detectors.

Iron cores have been used for the measurements described in the EXAMPLES. It is anticipated that ferrite cores will provide better signal response, since such cores exhibit substantially less hysteresis than iron cores.

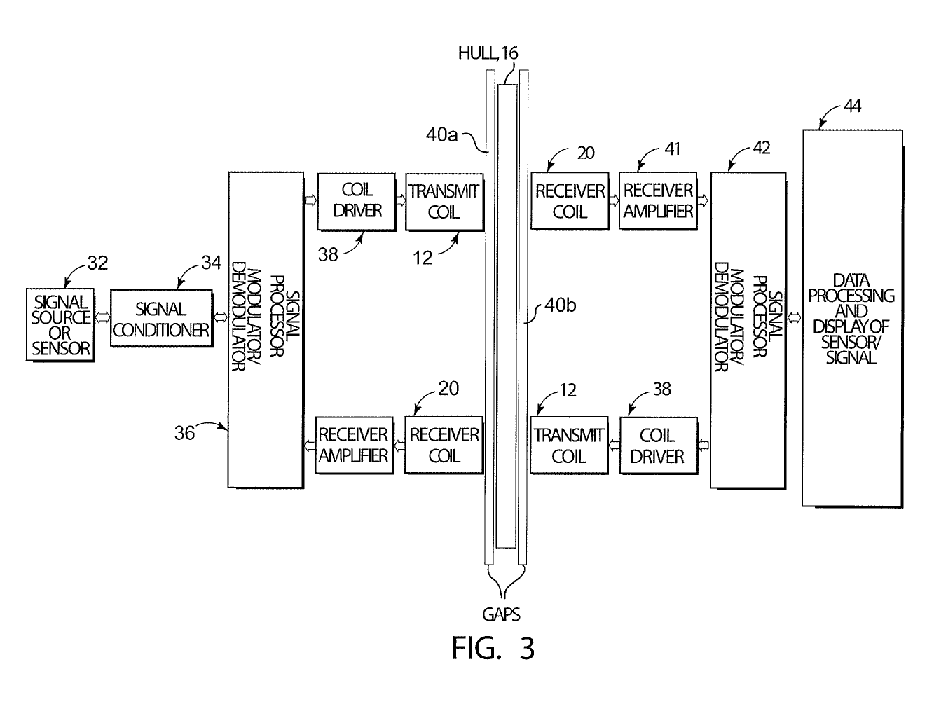

FIG. 3 is a block diagram of another embodiment of the magnetic induction apparatus of the present invention, illustrating bidirectional signal transmission capability. Sensor or other signal source, 32, disposed on one side of barrier 16 may be further electronically processed, such as filtering signal noise, as an example, using signal conditioner, 34. Signal processor, 36, digitizes the signal, and may add digital modulation to the digitized signal. The modulated signal is then directed into coil driver, 38, which generates an amplified modulated signal. The resulting signal drives transmitter coil 12 which generates a time-varying magnetic field bearing the digitized signal, which penetrates metal barrier 16 as well as any gaps, 40a, comprising water, air, or other material between the barrier and the transmitter coil. In some situations no gap will be present. On the other side of the barrier (potentially with another gap between the hull or barrier and the receiver, 40b), receiver coil 20 detects the time-varying magnetic field. This signal may be amplified using amplifier, 41, and digitized using signal processor, 42. The signal processor communicates with data processing and/or display unit, 44, another sensor, or some other device (not shown in FIG. 3).

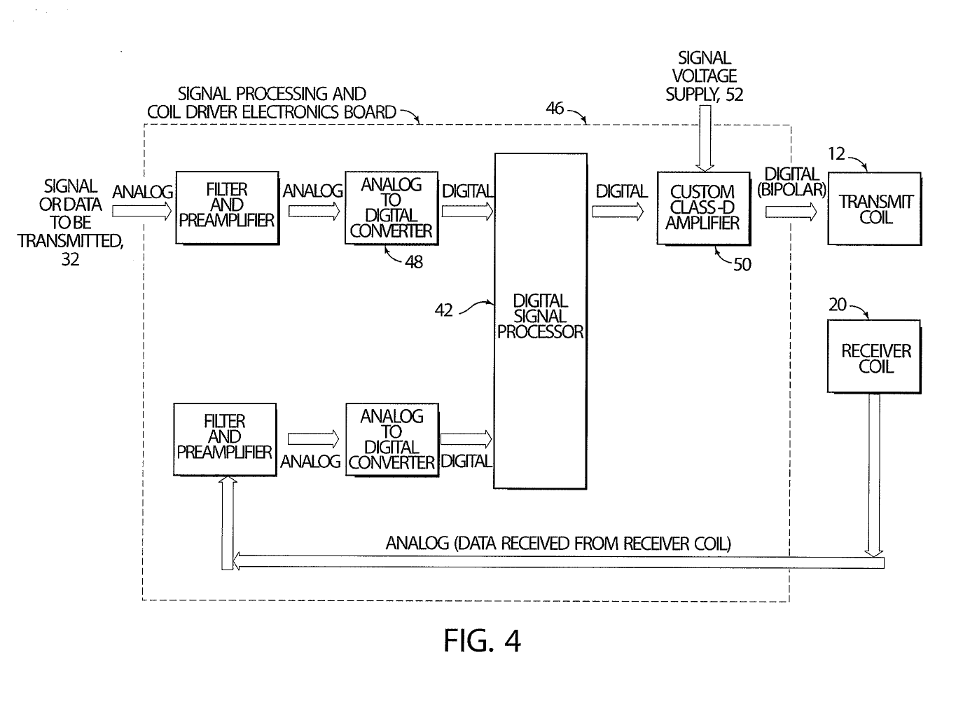

FIG. 4 is a block diagram of an embodiment of a digital signal processing apparatus and coil driver for use with the magnetic induction apparatus shown in FIG. 3 hereof. Signal processing apparatus and coil driver, 46, may include analog-to-digital converter, 48, for receiving either a conditioned or raw signal from the signal source or sensor and for receiving the (amplified) signal from receiver coil 20; a digital signal processor (DSP) 42 for modulation and demodulation, and having a digital output for controlling the coil driver circuitry. The coil driver circuitry may include full bridge class-D amplifier, 50, for converting digital pulses from the DSP to high-power bipolar coil drive signals using single-voltage supply, 52, for convenience of operation with battery powered systems.

Modulation may be digital modulation such as frequency shift keying (FSK), as an example. Using digital modulation permits communication for lower signal-to-noise ratios than are generally required using analog modulation techniques. Digital modulation therefore permits communication through thicker barrier materials at greater bandwidths than would otherwise be achievable using analog modulation. Another benefit of using digital modulation is that it is compatible with secure communication technology using advanced digital encryption techniques, including the 256-bit AES encryption standard. Thus, FSK exhibits robust operation at low signal levels, and immunity to noise resulting from the use of discrete frequencies to represent digital values. As an example, higher frequency segments may represent the digital value ‘1,’ while the lower frequency segments represent ‘0’. Noise immunity is high since any frequency that doesn't exactly match the predefined ‘1’ or ‘0’ frequency may be ignored.

Relatively low frequencies of the time varying magnetic fields were employed since testing has shown that lower frequencies pass through all tested materials more readily than do high-frequency signals. This is has been found to be especially true for partially ferromagnetic alloy hulls or barriers where time-varying magnetic fields from 0 Hz to 15 kHz are easily detectable by a receiver, while frequencies above approximately 20 kHz are significantly or completely blocked by the hull or barrier. By contrast, time-varying magnetic fields having frequencies greater than 1 MHz have been demonstrated by the present inventors to be detectable through most non-ferromagnetic materials, such as fiberglass, as an example.

Since very low-frequency (between about 1 Hz and tens of Hz) time-dependent magnetic fields have limited data transmission rate capabilities because data transmission rate is proportional to bandwidth which at low frequencies is small, it is advantageous to generate very low-frequency, time-varying magnetic fields to power sensors or other apparatus on the outside of a barrier using inductive power coupling. Thus, both wireless communication and the operation of sensors on one side of a barrier without the need for batteries or other wired power sources may be achieved.

High speed data (33.6 Kb/s) was transmitted through a Benthos 13 in. glass sphere without wall penetrators in a bench top test. It is expected that appreciable amounts of power (Watts) will be able to be transmitted as well through such a sphere.

As will be described in more detail hereinbelow, testing was performed through steel alloy barriers having significant ferromagnetic characteristics, a ferromagnetic alloy used in the manufacture of U.S. Navy submarine hulls, marine grade aluminum, fiberglass, air, and water. In each case, the material tested was of thickness appropriate for use in ship hull construction.

Having generally described the present method, more details thereof are presented in the following EXAMPLES.

### EXAMPLE 1

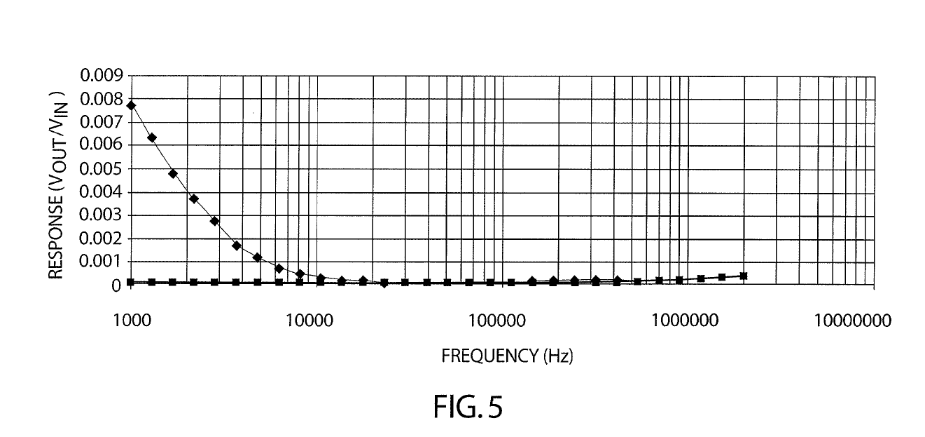

FIG. 5 is a graph of the response of the present apparatus defined as the ratio of the output voltage to the input voltage (upper curve), as a function of frequency for a 0.875″ thick, grounded slab of stainless steel. A signal voltage of 12 V rms and 0.145 A rms (1.43 W total power), was found to provide good signals in the receiver coil. A 3″ thick metallic barrier of similar material to that used as the pressure hull of Los Angeles class submarines was also shown to allow magnetic field transmission. The lower curve of FIG. 5 represents the noise floor for the apparatus employed.

### EXAMPLE 2

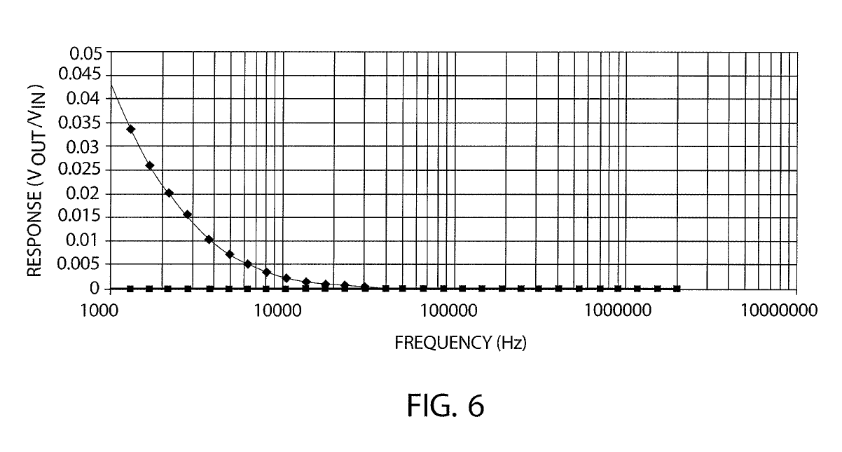

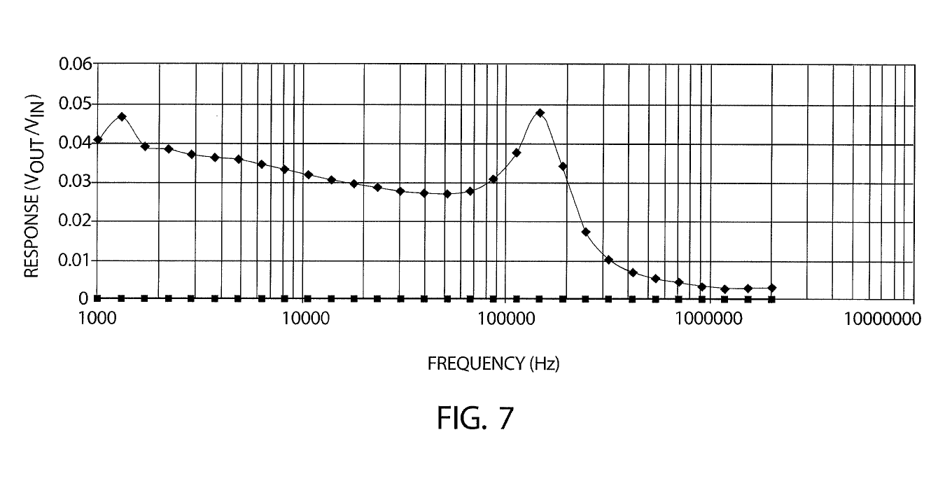

FIG. 6 is a graph of the response of the present apparatus defined as the ratio of the output voltage to the input voltage (upper curve), as a function of frequency for a 0.125″ thick, grounded slab of 5086 aluminum. The lower curve of FIG. 7 represents the noise floor for the apparatus employed.

### EXAMPLE 3

FIG. 7 is a graph of the response of the present apparatus defined as the ratio of the output voltage to the input voltage (upper curve), as a function of frequency for a grounded, 0.45″ thick slab of glass fiber reinforced polymer comprising three approximately equal thickness layers. It is believed by the present inventors that the increase in response at higher frequencies is likely an artifact of the measurement apparatus. The lower curve of FIG. 7 represents the noise floor for the apparatus employed.

The foregoing description of the invention has been presented for purposes of illustration and description and is not intended to be exhaustive or to limit the invention to the precise form disclosed, and obviously many modifications and variations are possible in light of the above teaching. The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for wireless transmission of a signal through a metal barrier, comprising the steps of:
generating a first signal;
producing a first time-varying magnetic field onto which the first signal is impressed on one side of the metal barrier; and
detecting the first time-varying magnetic field on the opposite side of the metal barrier from the side thereof where the first time-varying magnetic field is produced.

2. The method of claim 1, wherein said step of producing the first time-varying magnetic field is achieved using a first electrically conductive coil.

3. The method of claim 2, wherein said step of detecting the first time-varying magnetic field is achieved using a second electrically conductive coil.

4. The method of claim 3, wherein the first coil has a first coil diameter and the second coil has a second coil diameter, and wherein the first coil diameter is larger than the second coil diameter.

5. The method of claim 1, wherein said step of detecting the time-varying magnetic is achieved using a Hall probe.

6. The method of claim 3, further comprising the steps of:
generating a second signal;
producing a second time-varying magnetic field onto which the second signal is impressed on the side of the metal barrier opposite to that where the first time-varying field is produced; and
detecting the second time-varying magnetic field on the side of the metal barrier where the first time-varying magnetic field is produced, whereby said wireless transmission of a signal through a metal barrier is bidirectional.

7. The method of claim 6, wherein said step of producing the first time-varying magnetic field and said step of detecting the second time-varying magnetic field are achieved using the first electrically conductive coil, and wherein said step of detecting the first time-varying magnetic field and said step of producing the second time-varying magnetic field are achieved using the second electrically conductive coil.

8. The method of claim 1, wherein said step of detecting the first time-varying magnetic field further comprises extracting power from the first time-varying magnetic field.

9. Apparatus for wireless transmission of a signal through a metal barrier, comprising in combination:
first means for generating a first chosen signal;
a first electrically conductive coil effective for generating magnetic fields disposed on one side of said metal barrier;
a first coil driver for receiving the signal and for driving said first coil such that a first time-varying magnetic field is generated bearing the first signal;
first means responsive to the first time-varying magnetic field and disposed on the opposite side of said metal barrier from said first coil; and
first means for detecting the response of said first means responsive to the first time-varying magnetic field.

10. The apparatus of claim 9, wherein said first electrically conductive coil has a core.

11. The apparatus of claim 10, wherein said core is selected from the group consisting of iron and ferrite.

12. The apparatus of claim 9, wherein said means responsive to the time-varying magnetic field comprises a second electrically conductive coil having a core.

13. The apparatus of claim 12, wherein said core is selected from the group consisting of iron and ferrite.

14. The apparatus of claim 12, wherein said first electrically conductive coil has a first coil diameter and said second electrically conductive coil has a second coil diameter, and wherein the first coil diameter is larger than the second coil diameter.

15. The apparatus of claim 9, wherein said means responsive to the time-varying magnetic field comprises a Hall probe.

16. The apparatus of claim 9 further comprising:
second means for generating a second chosen signal;
a second electrically conductive coil effective for generating magnetic fields disposed on the other side of said metal barrier from said first coil;
a second coil driver for receiving the second signal and for driving said second coil such that a second time-varying magnetic field is generated bearing the second signal;
second means responsive to the second time-varying magnetic field and disposed on the same side of said metal barrier as said first coil; and
second means for detecting the response of said second means responsive to the second time-varying magnetic field, whereby said wireless transmission of a signal through a metal barrier is bidirectional.

17. The apparatus of claim 16, wherein said first electrically conductive coil produces the first time-varying magnetic field and is responsive to the second time-varying magnetic field, and wherein said second electrically conductive coil is responsive to the first time-varying magnetic field and produces the second time-varying magnetic field.

18. The apparatus of claim 9, wherein said means responsive to the first time-varying magnetic field is adapted to extract power from the first time-varying magnetic field.

19. A method for bidirectional wireless transmission of a signal through a metal barrier, comprising the steps of:
generating a first signal;
producing a first time-varying magnetic field onto which the first signal is impressed on one side of the metal barrier;
detecting the first time-varying magnetic field on the opposite side of the metal barrier from the side thereof where the first time-varying magnetic field is produced;
generating a second signal;
producing a second time-varying magnetic field onto which the second signal is impressed on the side of the metal barrier opposite to that where the first time-varying field is produced; and
detecting the second time-varying magnetic field on the side of the metal barrier where the first time-varying magnetic field is produced, whereby said wireless transmission of a signal through a metal barrier is bidirectional.

20. The method of claim 19, wherein said step of producing the first time-varying magnetic field and said step of detecting the second time-varying magnetic field are achieved using a first electrically conductive coil, and wherein said step of detecting the first time-varying magnetic field and said step of producing the second time-varying magnetic field are achieved using a second electrically conductive coil.

21. Apparatus for bidirectional wireless transmission of a signal through a metal barrier, comprising in combination:
first means for generating a first chosen signal;
a first electrically conductive coil effective for generating magnetic fields disposed on one side of said metal barrier;
a first coil driver for receiving the signal and for driving said first coil such that a first time-varying magnetic field is generated bearing the first signal;
first means responsive to the first time-varying magnetic field and disposed on the opposite side of said metal barrier from said first coil;
first means for detecting the response of said first means responsive to the first time-varying magnetic field;
second means for generating a second chosen signal;
a second electrically conductive coil effective for generating magnetic fields disposed on the other side of said metal barrier from said first coil;
a second coil driver for receiving the second signal and for driving said second coil such that a second time-varying magnetic field is generated bearing the second signal;
second means responsive to the second time-varying magnetic field and disposed on the same side of said metal barrier as said first coil; and
second means for detecting the response of said second means responsive to the second time-varying magnetic field, whereby said wireless transmission of a signal through a metal barrier is bidirectional.

22. The apparatus of claim 21, wherein said first electrically conducting coil produces the first time-varying magnetic field and detects the second time-varying magnetic field, and wherein said second electrically conducting coil detects the first time-varying magnetic field and produces the second time-varying magnetic field.
